(19) United States
(12) Patent Application Publication
(10) Pub. No.: US 2023/0375468 A1
(43) Pub. Date: Nov. 23, 2023

(54) MULTI-MONOCHROMATIC LIGHT SOURCE SYSTEM FOR SLOPE SPECTROSCOPY

(71) Applicant: Repligen Corporation, Waltham, MA (US)

(72) Inventors: Matthew Muller, Cranford, NJ (US); Richard Hall, III, Bernardsville, NJ (US); Yusheng Zhang, Stewartsville, NJ (US); Peter Halatin, Howell, NJ (US)

(73) Assignee: Repligen Corporation, Waltham, MA (US)

(21) Appl. No.: 18/198,706

(22) Filed: May 17, 2023

Related U.S. Application Data
(60) Provisional application No. 63/343,370, filed on May 18, 2022.

(51) Int. Cl. G01N 21/33; G01N 21/25; G01N 30/86

(52) U.S. Cl. CPC G01N 21/33; G01N 21/255; G01N 30/8627; G01N 2030/027

(57) ABSTRACT

An apparatus may include a light emitting diode (LED) assembly, comprising a plurality of LEDs that output radiation at a plurality of different wavelengths, respectively. The LED assembly may be arranged to output a composite probe signal at a plurality of instances, wherein the composite probe signal comprises a plurality of probe signals, generated from the plurality of LEDs, respectively. The apparatus may also include a measurement module that includes an optic probe to direct the composite probe signal through a fluid sample, while moving between a plurality of probe positions at the plurality of instances. The measurement module may include a detector, disposed to detect, at the plurality of instances, a transmitted intensity of the composite probe signal at the plurality of different wavelengths after the composite probe signal passes through the fluid sample.

### BACKGROUND OF THE DISCLOSURE

### Field of the Disclosure

This present application claims the benefit of priority under 35 U.S.C. § 119 to U.S. Provisional Application Ser. No. 63/343,370, entitled “MULTI-MONOCHROMATIC LIGHT SOURCE SYSTEM FOR SLOPE SPECTROSCOPY” filed on May 18, 2022, the disclosure of which is incorporated herein by reference in its entirety.

### FIELD OF THE DISCLOSURE

Embodiments of the disclosure relate generally to spectroscopic analysis, and more particularly to solution analysis using light source coupled with a variable path length measurement system.

### DISCUSSION OF RELATED ART

Absorption spectroscopy is used to measure composition and/or properties of a material in any phase, gas, liquid, solid. For example, the optical absorption spectra of liquid substances may be measured to determine concentration or other properties of a species of interest, within a liquid medium. An absorption spectra may provide the distribution of light attenuation (due to absorbance) as a function of light wavelength. In a known spectrophotometer the sample substance to be studied is placed in a transparent container, so that electromagnetic radiation (light) of a known wavelength, λ, (i.e. ultraviolet, infrared, visible, etc.) and intensity, I, may be measured after passing through the transparent container, using a suitable detector.

Known ultraviolet (UV)/visible spectrophotometers utilize containers such as standard cuvettes which containers may have a standard cm path length through which the incident light is conducted within the liquid containing the substance to be measured. For a sample consisting of a single homogeneous substance having a concentration c, the light transmitted through the sample will follow a relationship know as Beer's Law: A=εCL where A is the absorbance (also known as the optical density (OD) of the sample at wavelength λ where OD=the −log of the ratio of transmitted light to the incident light), ε is the absorptivity or extinction coefficient (normally at constant at a given wavelength), C is the concentration of the sample, and L is the path length of light through the sample. Thus, in principle, information regarding concentration of the homogenous substance may be determined based upon recorded light intensity of a signal passing through the sample container. However, under some circumstances, the determination of concentration in such apparatus may be difficult. Often a compound of interest in solution is highly concentrated. For example, certain biological samples, such as monoclonal antibodies, proteins, DNA or RNA are often isolated in concentrations that fall outside the linear range of the spectrophotometer when absorbance is measured. Therefore, dilution of the sample is often required to measure an absorbance value that falls within the linear range of the instrument. Frequently multiple dilutions of the sample are required, which leads to both dilution errors and the removal of the sample diluted for any downstream application. It is therefore useful to take existing samples without knowledge of the possible concentration and to measure the absorption of these samples without dilution. One resulting feature common to these known ultraviolet (UV)/visible spectrophotometers is that the path length L be known with great accuracy so that an accurate concentration measurement can be made.

To address these challenges, a technology based upon a variable path length spectrophotometer has recently been developed. This type of spectroscopy system may generally employ a known light source, such as a source based upon a UV/visible spectrophotometer. Light from the UV/visible spectrophotometer is then directed to a special probe in an analysis instrument that is arranged to dynamically change the path length L in a special sample chamber during an absorbance measurement. Thus, radiation that is generated from the UV/visible spectrophotometer source is detected after passing through the sample chamber, while the movement of the probe varies the path length L through multiple different positions. As such, a series of measurements are produced that generate a different value of A for each different value of L, in a manner that does not require knowledge of any particular path length L, in order to determine the concentration C.

While such variable path length spectroscopy may be adapted for in-line measurements of a sample, while conducted through a production system, for example, the instrumentation required for such measurement scenarios may require extensive installation effort and an undue amount of space. For example, a UV/visible photospectrometer system used as a light source may occupy several cubic feet of space and may have a weight on the order of several tens of kilograms. Moreover, measurement using a UV/visible photospectrometer system as a light source may require several seconds or more to acquire a sufficient data to determine a concentration for a given substance. With respect to these and other considerations, the present disclosure is provided.

### SUMMARY OF THE DISCLOSURE

In one embodiment, an apparatus is provided. The apparatus may include a light emitting diode (LED) assembly, comprising a plurality of LEDs that output radiation at a plurality of different wavelengths, respectively. The LED assembly may be arranged to output a composite probe signal at a plurality of instances, wherein the composite probe signal comprises a plurality of probe signals, generated from the plurality of LEDs, respectively. The apparatus may also include a measurement module that includes an optic probe to direct the composite probe signal through a fluid sample, while moving between a plurality of probe positions at the plurality of instances. The measurement module may include a detector, disposed to detect, at the plurality of instances, a transmitted intensity of the composite probe signal at the plurality of different wavelengths after the composite probe signal passes through the fluid sample.

In another embodiment, a method of determining a concentration of at least one material is provided. The method may include providing an LED assembly comprising a plurality of LEDs to direct a composite probe signal through a fluid sample that contains the material, wherein the composite probe signal comprises a plurality of probe signals, generated at a plurality of different wavelengths. The method may also include directing the composite probe signal through a probe when the probe is disposed at a first position within a sample vessel that contains the fluid sample, wherein the first path defines a first path length L₁ of the composite probe signal through the fluid sample, and measuring, a transmitted intensity I₁(lₙ) of the composite probe signal after passing through the fluid sample, at a set of n wavelengths of the plurality of wavelengths. The method may further include directing the composite probe signal through the probe when the probe is disposed at a second position, defining a second path length L₂ of the composite probe signal through the fluid sample, measuring a transmitted intensity I₂(lₙ) of the composite probe signal after passing through the fluid sample at the set of n wavelengths of the plurality of wavelengths, and determining a concentration C of the at least on material based upon L₁, I₁(lₙ), L₂, and I₂(lₙ).

In a further embodiment, an absorption spectroscopy system may include a light emitting diode (LED) assembly, comprising a plurality of LEDs that output radiation at a plurality of different wavelengths, respectively. The LED assembly arranged to output a composite probe signal at a plurality of instances, wherein the composite probe signal comprises a plurality of probe signals, generated from the plurality of LEDs, respectively The absorption spectroscopy system may further include a measurement module, where the measurement module includes an optic probe to direct the composite probe signal through a fluid sample, while moving between a plurality of probe positions at the plurality of instances. The measurement module may also include a detector, disposed to detect, at the plurality of instances, a transmitted intensity of the composite probe signal at the plurality of different wavelengths after the composite probe signal passes through the fluid sample. The absorption spectroscopy system may also include a controller arranged to synchronize a triggering of the plurality the plurality of LEDs with the data acquisition from the detector at the plurality of instances.

### BRIEF DESCRIPTION OF THE DRAWINGS

FIG. 1 depicts general features of an absorption spectroscopy apparatus, in accordance with embodiments of the disclosure;

FIG. 2 depicts operation of an absorption spectroscopy apparatus, in accordance with some embodiments of the disclosure;

FIG. 3A depicts general features of an absorption spectroscopy system, in accordance with further embodiments of the disclosure;

FIG. 3B depicts one variant of the system of FIG. 3A; and

FIG. 4 depicts exemplary absorption spectra, according to embodiments of the disclosure;

FIG. 5 is a composite graph, depicting change in position of a probe as a function of time, as well as change in optical intensity as a function of different wavelength, according to embodiments of the disclosure;

FIG. 6 illustrates an exemplary process flow.

### DESCRIPTION OF EMBODIMENTS

According to embodiments of the disclosure, a multi-monochromatic light source (MMLS) is provided to be coupled to a variable-pathlength-measurement (VPT) apparatus. The MMLS and VPT apparatus together provide a flexible absorption spectroscopy apparatus that can be readily integrated into a variety of production, research and measurement systems, including chromatography protein systems purification systems, filtration systems, and other fluid processing systems. In particular, the form factor of these apparatus in the present embodiments may entail a size of approximately 6″ by 3″ by 3″ for a multi-monochromatic light source having 3 LEDs, and approximately 12″ by 12″ by 12″ for a system including light source and VPT apparatus according to a non-limiting embodiment. Note that the size of the multi-monochromatic light source will vary according to how many LEDs are included in the light source, such as 2 LEDs, 3, LEDs, 4 LEDs, etc.

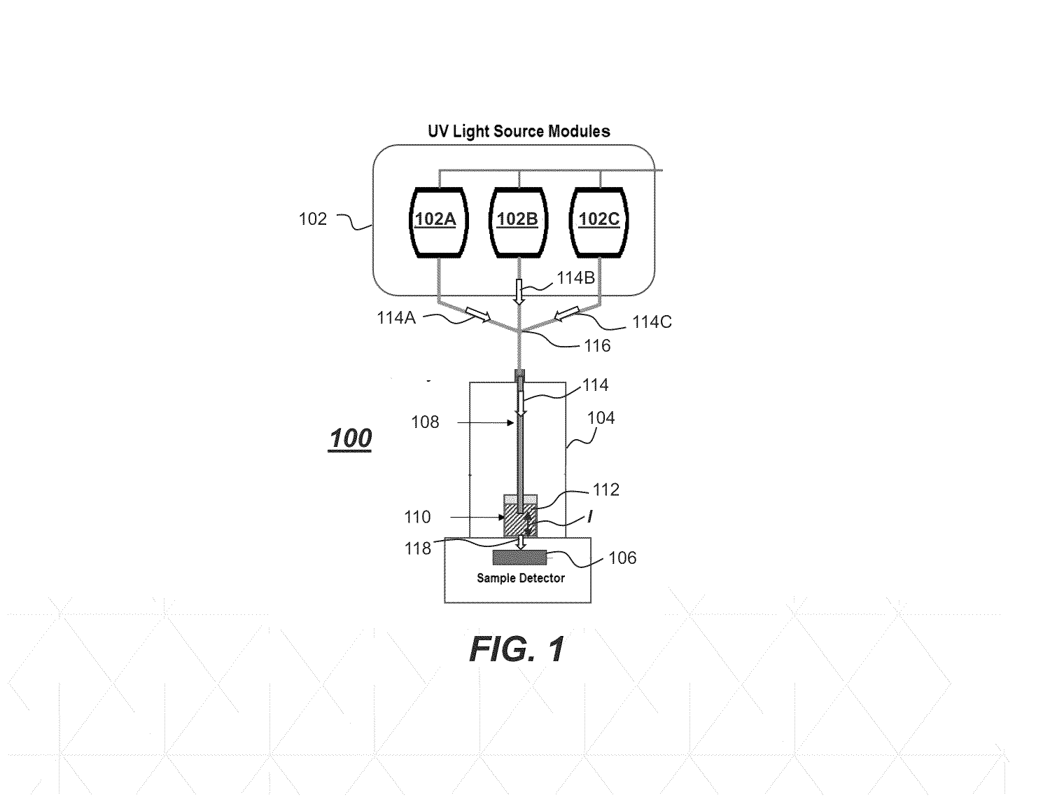

FIG. 1 depicts an absorption spectroscopy apparatus, shown as system 100, in accordance with embodiments of the disclosure. The system 100 may include an MMLS 102, and a measurement instrument, shown as measurement module 104, coupled to the MMLS 102, and a detector 106, disposed next to the measurement module 104. The MMLS 102 may be configured as a light emitting diode (LED) assembly, including a plurality of LEDs that output radiation at a plurality of different wavelengths, respectively. Such an assembly of LEDs may be collocated in a common housing, or may be located separately from one another, according to different embodiments.

The LED assembly, meaning MMLS 102, is shown as having three separated LEDS, including LED 102A, LED 102B, and LED 102C. The MMLS 102 is arranged to output a composite probe signal 114, where the composite probe signal 114 is formed from a plurality of probe signals, generated from the plurality of LEDs, respectively. These probe signals are shown as probe signal 114A, probe signal 114B, and probe signal 114C. However, in other embodiments the MMLS 102 may include two LEDs or more than three LEDs. Generally, the LEDs of MMLS 102 may emit radiation in the range of 200 nm to 1000 nm, meaning between the near ultraviolet and near infrared range, according to non-limiting embodiments of the disclosure.

As depicted in FIG. 1, the system 100 further includes an optical coupler 116, arranged to receive the plurality of probe signals from the plurality of LEDs, such as probe signal 114A, probe signal 114B, and probe signal 114C, in the embodiment depicted in FIG. 1. The optical coupler 116 is arranged to output the plurality of probe signals as the composite probe signal 114 to a measurement module 104. In some embodiments, a separate narrow bandpass filter (not shown) may be provided between each LED of the MMLS 102 and the optical coupler 116, so that the probe signal 114A, probe signal 114B, and probe signal 114C may be provided as essentially multi-monochromatic radiation. According to different embodiments of the disclosure, the LEDs of MMLS 102, such as LED 102A, LED 102B, and LED 102C, may each emit unfiltered radiation having a peak whose bandwidth or halfwidth is between 10 nm and 50 nm. Thus, after passing through a narrow bandpass filter, the bandwidth of each of the probe signal 114A, probe signal 114B, and probe signal 114C that are combined at optical coupler 116 may be reduced to less than 1 nm, essentially constituting three peaks that are each deemed to constitute monochromatic radiation.

As shown in FIG. 1, the measurement module 104 may include a optic probe 108, to direct the composite probe signal 114 through a fluid sample 112. The optic probe 108 may be movable between a plurality of probe positions, along a vertical direction as represented in the figure. As such, the optic probe 108 may change the distance that the composite probe signal 114 travels through the fluid sample 112. This distance is represented by a path length 1, as shown.

The system 100 further includes a detector 106, disposed to detect, a detected optical intensity of the composite probe signal 114 at the plurality of different wavelengths generated by LED 102A, LED 102B, and LED 102C, after the composite probe signal 114 passes through the fluid sample 112.

In operation, the system 100 may be used to determine the concentration C of a material or substance that is contained in the fluid sample 112. In accordance with the principles of slope spectroscopy, the system 100 may determine C by measuring changes in absorption of the composite probe signal 114 as a function of changes in the path length l, shown in FIG. 1.

In brief, the determination of the concentration C is based upon the Beer Lamber law, where the concentration C of a material in a sample may be determined as A/eL, where A is the absorbance and e is the molar absorptivity. In turn, A is determined as log₁₀(I₀/I), where I₀ is the intensity of the incident radiation that forms the composite probe signal 114 before passing through the fluid sample 112, and I is the intensity of the attenuated radiation that is shown as the attenuated probe signal 118, representing the composite probe signal 114 after passing through the fluid sample 112. Because the intensity of the attenuated probe signal 118 will vary according to changes in path length L, the change in I as a function of path length L, change can be used to directly determine the change in absorbance A as a function of change in path length L. For example, according to the approach of slope spectroscopy, the Beer Lambert law may be recast as A/L, =e C, and extended further to DA/DL, =e C, where the entity DA/DL is deemed a slope parameter m. Thus, measurement of the variation in absorbance DA with the variation in path length L will directly lead to determination of the concentration C, given knowledge of the molar absorptivity for a given substance. It can readily be shown that DA may be determined by a series of measurements of intensity of radiation emitted from MMLS 102, as the path length L is varied. This relationship is detailed in Eq. (1):

$$Δ A = A 2 - A 1 = log \frac{I 02}{I 2} - log \frac{I 01}{I 1} \qquad ( 1 )$$

where I₀₁ represents the intensity of composite probe signal 114 at a first instance corresponding to a first path length L₁, I₀₂ represents the intensity of composite probe signal 114 at a second instance corresponding to a second path length L₂, I₁ represents the intensity of attenuated probe signal 118 at the first instance, and I₂ represents the intensity of attenuated probe signal 118 at the second instance. Thus, from Eq (1), the change in absorbance as a function of change in path length, DA/DL, or m is determined by dividing Eq (1) by the change in path length. Thus, the slope parameter DA/DL or m is equal to:

$$( log \frac{I 02}{I 2} - log \frac{I 01}{I 1} ) / ( {L}_{2} - {L}_{1} ) . \qquad ( 3 )$$

Assuming that under some circumstances, changes in I₀ can be neglected between a first instance when an intensity measurement (I₁) is recorded at a first path length L₁ and a second instance when an intensity measurement (I₂) is recorded at a second path length L₂, then DA can be determined directly as log I₁−log I₂. In turn, from Beer Lambert law, DA/DL is equal to eC, where DL is equal to L₁−L₂. Thus, the slope parameter m, or DA/DL is determined simply by (log I₁−log I₂)/L₁-L₂.

Thus, the system 100 may be employed to readily determine the concentration C of a material in a fluid sample, by varying the path length (to determine DL) of the composite probe signal 114 as the incident radiation generated by MMLS 102 (composite probe signal 114) passes through the fluid sample 112, and detecting changes in intensity of the attenuated probe signal 118 (to determine DA).

More particularly, as regards the composite probe signal 116, the detector 106 may be arranged to detect an intensity of multiple different peaks that form the attenuated probe signal 118 at different instances where the path length L varies between the different instances. Thus, at a first instance, the composite probe signal 114 is directed through the optic probe 108 when the optic probe 108 is disposed at a first position within the sample vessel 110, where the optic probe 108 defines a first path length L₁ of the composite probe signal 114 through the fluid sample 112. At this first instance, the transmitted intensity of the composite probe signal 114 may be measured at different wavelengths in the following manner. Said differently, the intensity of the attenuated probe signal 118 is measured at a plurality of wavelengths, corresponding to a plurality of peaks in intensity of the attenuated radiation, where each peak of the plurality of peaks represents monochromatic radiation.

At a first instance, when optic probe 108 defines a first path length L₁ let the intensity of the attenuated probe signal 118 for a first wavelength be represented as I₁(l₁), the intensity of the attenuated probe signal 118 for a second wavelength be represented as I₁(l₂), the intensity of the attenuated probe signal 118 for an nth wavelength be represented as I₁(lₙ). At a second instance, when optic probe 108 defines a second path length L₂ let the intensity of the attenuated probe signal 118 for the first wavelength (selected to correspond to a first peak) be represented as I₂(l₂), the intensity of the attenuated probe signal 118 for the second wavelength be represented as I₂(lₙ), the intensity of the attenuated probe signal 118 for an nth wavelength be represented as I₂(lₙ). Let the intensity of the attenuated probe signal 118 at a set of n wavelengths be represented by I₁(lₙ) for the first instance, and be represented by I₂(lₙ) for the second instance. To determine a concentration C value for a material in fluid sample 112 according to the principles of slope spectroscopy, the system 100 will move the optic probe 108 between the first instance and the second instance, while the composite probe signal 114 is generated at both instances. The system 100 will thus generate values of L₁, I₁(lₙ), L₂, and I₂(lₙ), from which values a concentration C value may be determined for any given wavelength of the set of n wavelengths.

Note that in certain embodiments, the LED 102A, LED 102B, and LED 102C are driven by three separate trigger signals to output three separate probe signals at three separate wavelengths. The recording of the three separate probe signals as the attenuated probe signal 118 at the detector 106 may thus occur in serial fashion, while the interval between triggering the first probe signal of the composite probe signal and the recording of the last probe signal of the attenuated probe signal may be on the order of microseconds. Thus, in the present disclosure, this microsecond-spanning interval for triggering three separate probe signals to form a composite probe signal 114, and the recording of three separate attenuated signals as the attenuated probe signal 118 may be deemed to constitute a single ‘instance’ because of the short duration.

Said differently, for a given instance when the probe is positioned at a first position, the duration of collection time that is spanned for triggering multiple LEDs in serial fashion to emit the separate probe signals that form a composite probe signal and detection of the composite probe signal may represent a small fraction of the time between the given instance and a subsequent instance when the probe has moved to a second position and the multiple LEDS are triggered in serial fashion to generate the next composite probe signal. In particular instances, the duration of collection time may be at least one order of magnitude less than the time between successive instances.

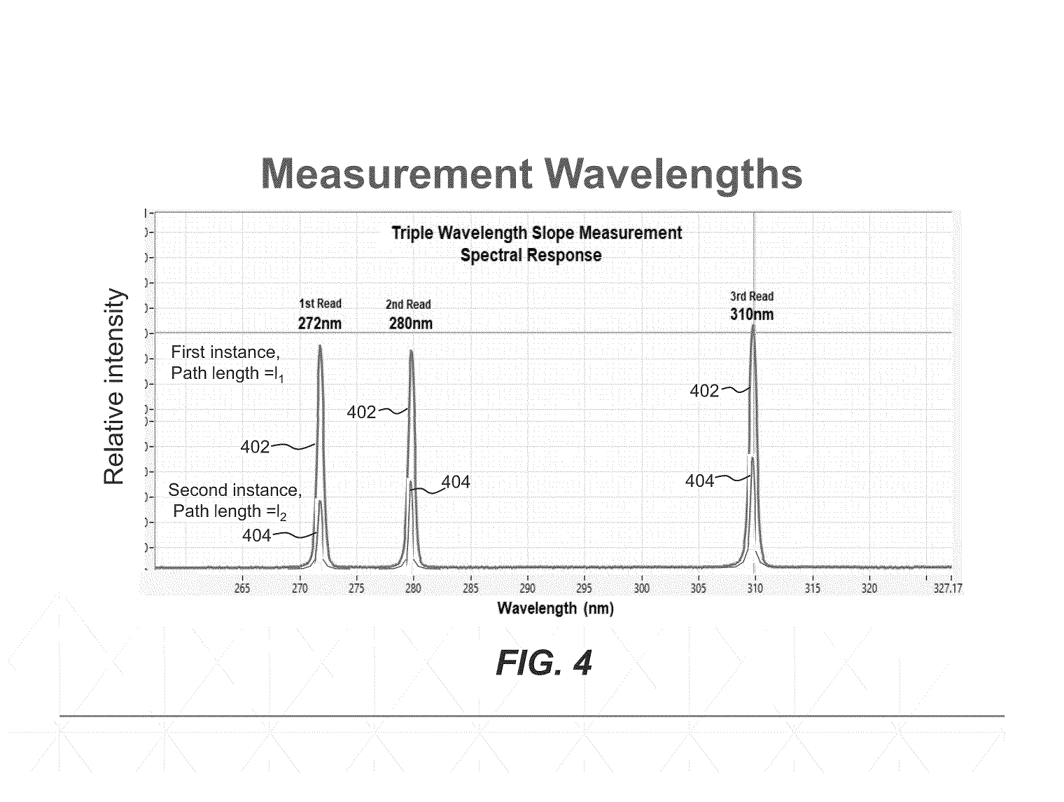

To further explain the determination of concentration C using a plurality of monochromatic radiation sources, FIG. 4 depicts exemplary absorption spectra, according to embodiments of the disclosure. In this example, the graph of FIG. 4 depicts detected radiation intensity as a function of wavelength in the near UV range. Two spectra, spectrum 402 and spectrum 404, are shown, each composed of a series of three peaks, representing the detected intensity of UV light emitted from three different monochromatic sources, emitting at 272 nm, 280 nm, and 310 nm.

According to various embodiments of the disclosure, and consistent with the embodiment of FIG. 1, the peaks represent what is termed multi-monochromatic radiation, in that the half width of the peaks is less than 1 nm. The spectra represent data collected after radiation is emitted from three UV LED sources and is passed through a narrow bandpass filter. As such, the spectrum 402 presents data collected at a first instance when the path length of the multi-monochromatic radiation is directed through a probe that is disposed at a first position, defining a path length L₁ through a fluid sample. Likewise, the spectrum 404 presents data collected at a second instance when the path length of the multi-monochromatic radiation is directed through a probe that is disposed at a second position, defining a path length L₂ through the fluid sample. Given that, as noted above, the concentration C will equal DA/(DLe), the determination of the difference in absorbance between spectrum 404 and spectrum 402 (DA) will lead directly to C, because DL is given by L₂-L₁. More particularly, C may be determined for each peak of the multi-monochromatic spectra, by calculating the change in intensity of a given peak between the first instance and the second instance.

Continuing with the example of FIG. 4, and according to some embodiments of the disclosure, a concentration value C₁ may be determined at a plurality of different frequencies (wavelengths) for a single substance, based upon the detected optical intensity of a composite probe signal as recorded at a plurality of probe positions, meaning different values of L. Said differently, in some embodiments, the change in absorbance for multiple different monochromatic radiation peaks may be used to determine the concentration C for a single substance.

In other embodiments, measurement of changes in absorbance of monochromatic radiation at a first frequency (wavelength) of a spectrum having a plurality of monochromatic peaks at different wavelengths, will correspond to measurement of a concentration of a first substance, such as DNA. At the same time measurement of changes in absorbance of monochromatic radiation at a second frequency (wavelength) of the spectrum will correspond to measurement of a concentration of a second substance, such as RNA.

According to various embodiments of the disclosure, a given multi-monochromatic spectrum, such as spectrum 402 or spectrum 404, may be generated at a single instance. For example, the spectrum 402 may be generated by triggering three different LEDs, emitting radiation at three different wavelengths, to emit three different probe signals in serial fashion over a short duration that are combined into a composite probe signal. Note that with the use of suitable present-day electronics, to a user there will be no observable delay in recording the thee peaks forming the spectrum 402 at a first instance; likewise, there will be no observable delay in recording the thee peaks forming the spectrum 404 at a second instance. In various embodiments, a composite probe signal may be detected at a single instance by a single detector that is suitable to detect radiation over the wavelength range that encompasses the three different wavelengths. Thus, the spectrum 402 and spectrum 404 may be generated and collected (detected) over an interval required to trigger LED devices and to record photon intensity by an electronic detector, such as on the order of microseconds, which interval may be referred to a single instance, as noted previously.

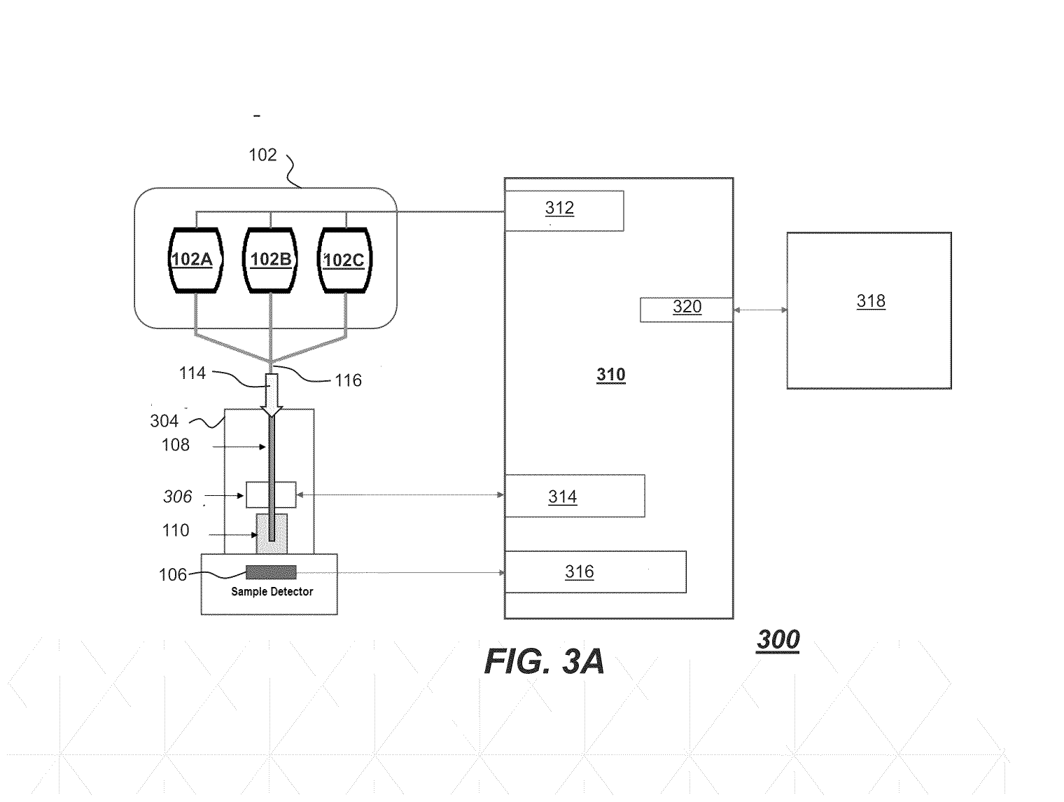

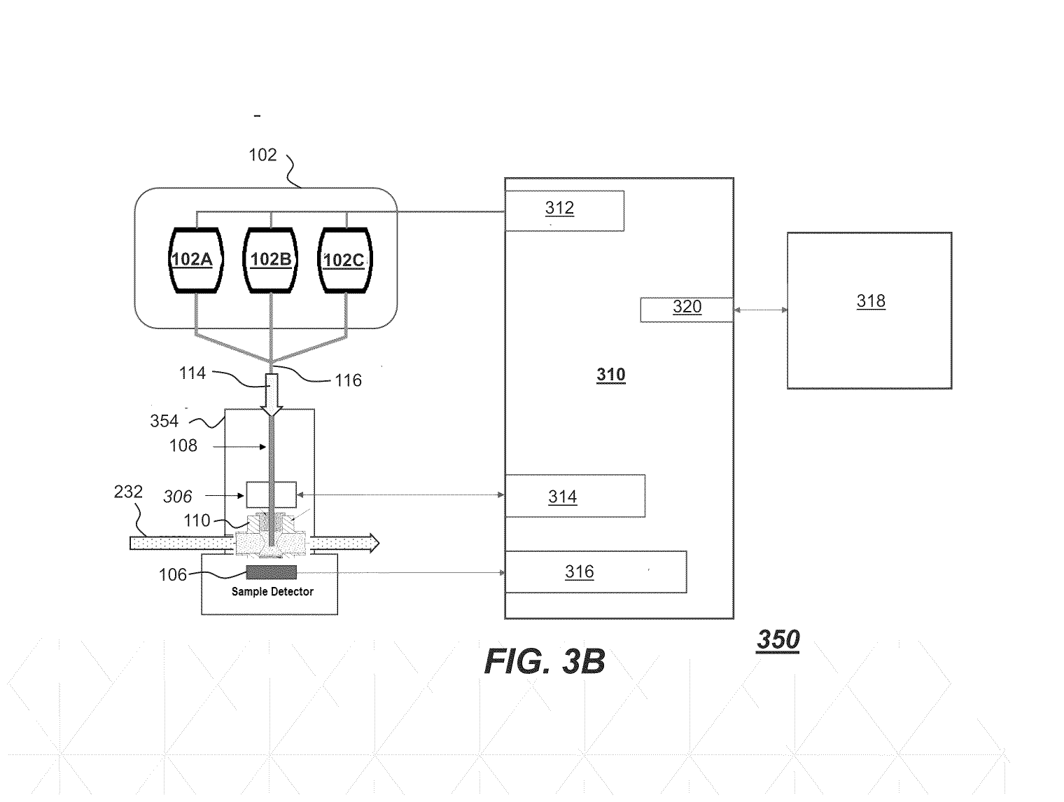

According to various embodiments, discussed in more detail with respect to FIGS. 3A, 3B, a controller may be provided to arrange the triggering of the different LEDs to be in synchronization with the data acquisition from the detector to record the different spectra at different instances.

Moreover, the time required to generate multiple spectra, recorded at different path lengths L, at different instances, including the time to move an optic probe, may be on the order of tenths or a few seconds. Thus, the system according to FIG. 1 may generate sufficient data to determine concentration of a substance based upon multiple different wavelengths, or to determine concentration of multiple substances, corresponding to different wavelengths, all within a few seconds or less.

While the above examples focus on the use of collecting multi-monochromatic spectra at two different path lengths to determine absorbance change, and thus concentration C, in various embodiments, multi-monochromatic spectra may be collected at three or more different path lengths L. In these embodiments, the determination of C may be based upon known known linearization techniques where DA/Dl is determined generally as follows.

As discussed above, under some circumstances, changes in I₀ can be neglected between a first instance when an intensity measurement (I₁) is recorded at a first path length L₁ and a second instance when an intensity measurement (I₂) is recorded at a second path length L₂, so that DA can be determined directly as log I₁−log I₂. For each different wavelength of multi-monochromatic radiation, this approach may be readily extended to record multiple different measurements of I without measuring I₀ at multiple different probe positions to more accurately determine concentration, for example. In other words, I₁ and L₁ are recorded at a first probe position, I₂ and L₂ are recorded at a second probe position, I₃ and L₃ are recorded at a third probe position, and so forth. In some implementations, the determination of C may be made in the following manner, where C=(DA/DL)e, according to the Beer Lambert law. A value of logI is determined for each value of I. A linear regression is performed based on a set of data plotting log I as a function of L for three or more probe positions, in order to determine a regression line whose slope is proportional to =(DA/DL). In this case DA and DL are determined from the values of the respective logI and L values at opposite ends of the regression line, rather than the exact values of L₁, logI₁, Lₙ, and logIₙ, for example. In this manner, the concentration C that is calculated may more accurately reflect the true value in comparison to a concentration determined from one pair of intensity and path length measurements performed at just two probe positions. Thus, this linear regression approach may be applied to determine a concentration value C for multiple different peaks of a multi-monochromatic spectrum, be performing a linear regression based upon a series of data points logI₁, L₁; log I₂, L₂, logI₃, L₃; etc., for each peak.

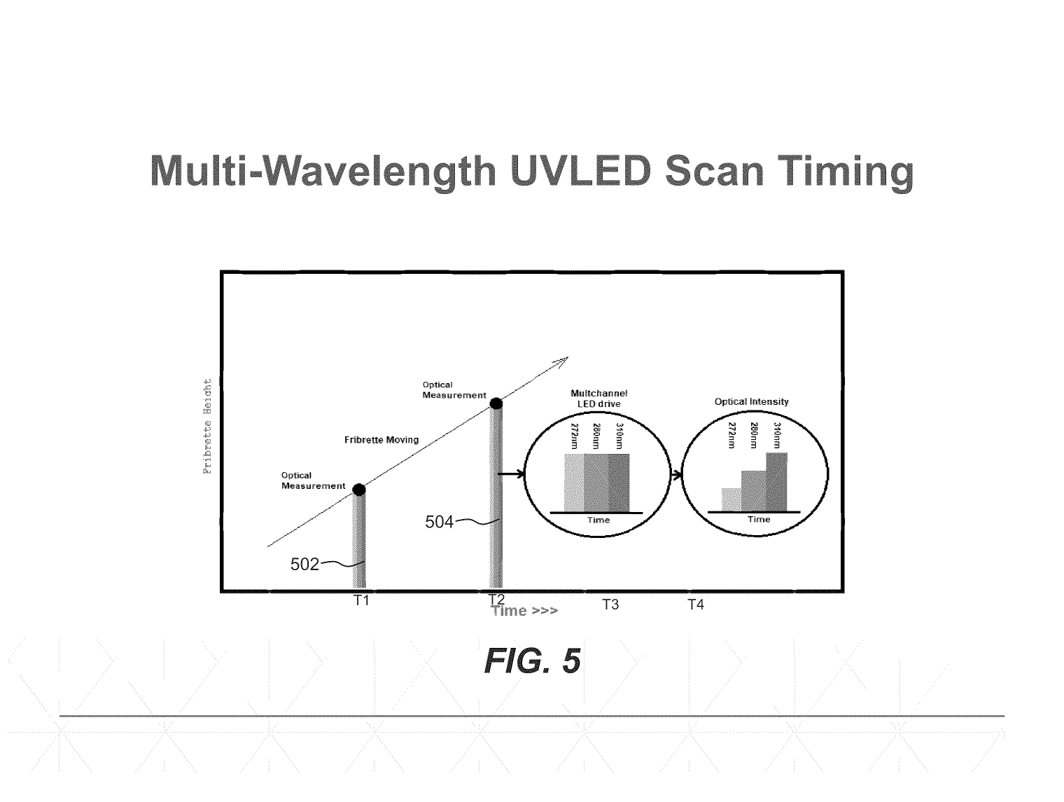

In some embodiments, a series of multi-monochromatic spectra may be collected while a probe is moved, either in stop-and-go fashion, or continuously, so that concentration C may be determined based on the multiple peaks. FIG. 5 is a composite graph, depicting change in position of a probe as a function of time, as well as change in optical intensity as a function of different wavelength, according to embodiments of the disclosure. In FIG. 5, the y-axis represents the position or height of an optical probe (fibrette) with respect to a detector or sample vessel. Thus, the y-axis also represents the path length L of radiation traveling through the fluid sample from the probe tip to a sample vessel wall. The histogram 502 represents the fibrette position at a first instance T1, while the histogram 504 represents the fibrette position at a second instance T2. At each of these instances, an assembly of LEDs, such as three LEDs, are triggered to emit radiation at the three different wavelengths indicated. As shown in the insets, the optical intensity of the detected radiation may vary between the different wavelengths at a given instance. Moreover, between T1 and T2, the optical intensity of the detected radiation at a given wavelength will also vary, so that DA/DL between T1 and T2 may be determined for each wavelength. Moreover, this determination of DA/DL may be repeated (for example, at a time T3, T4, etc.), either in step-like fashion, or as a probe is continuously moved, while the LED assembly is repeatedly triggered to generate additional multi-monochromatic spectra for different probe positions. Thus, since the concentration C will be proportional to of DA/DL, changes in the measured of DA/DL may be monitored as a function of time to determine any changes in C for a given substance over time.

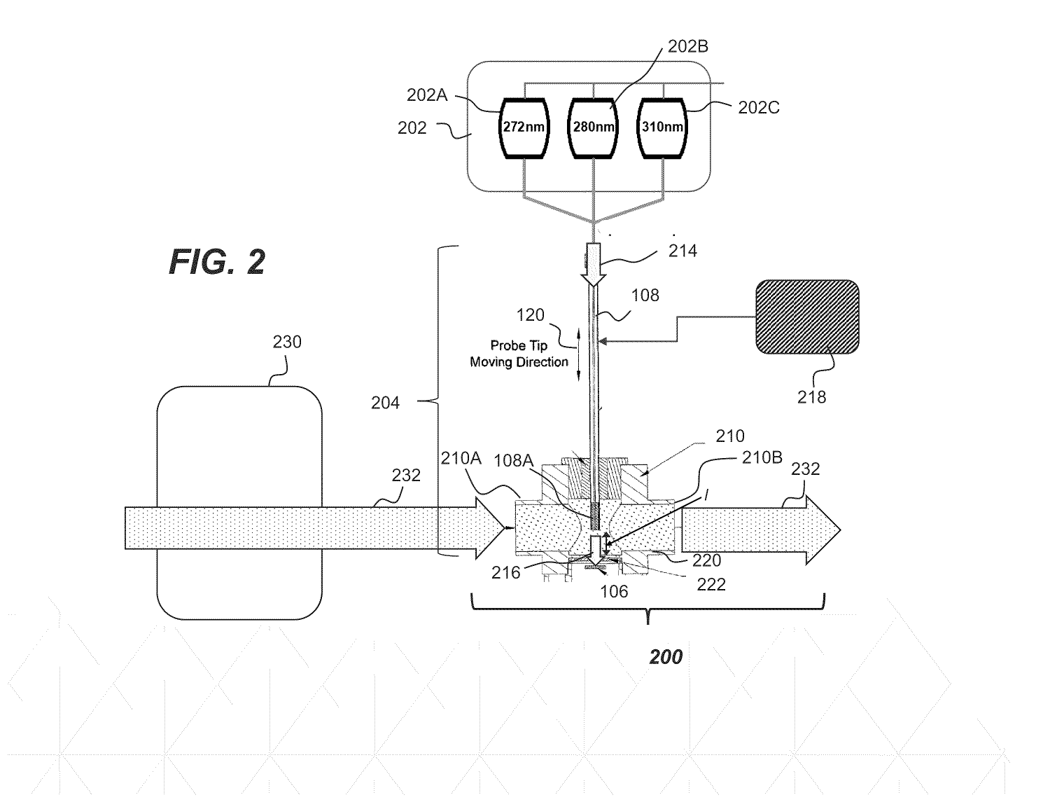

Note that in accordance with different embodiments of the disclosure, the sample vessel 110 may be a self-contained vessel, or may represent a chamber through which a fluid sample passes during measurement. FIG. 2 depicts operation of an absorption spectroscopy apparatus 200, in accordance with some embodiments of the disclosure. For the purposes of simplicity, in this example, an LED assembly, shown as MMLS 202, includes three separated LEDS, including LED 202A, LED 202B, and LED 202C. However, the MMLS 202 may include fewer or a greater number of LEDs in other variants. Like the embodiment of FIG. 1, the MMLS 202 is arranged to output a composite probe signal 214, where the composite probe signal 214 is formed from a plurality of probe signals, generated from the plurality of LEDs, respectively. For clarity, these individual probe signals are not shown. In this particular example, LED 202A, LED 202B, and LED 202C emit radiation at 272 nm, 280 nm, and 310 nm, as illustrated.

The absorption spectroscopy apparatus 200 includes a measurement system 204, including a movable optic probe 108 that is driven by a drive component 218 to translate along a probe axis 120. The measurement system 204 may include a sample chamber vessel 210, an inlet port 210A to admit a fluid sample 232, and an outlet port 210B to conduct the fluid sample out of the sample chamber vessel 210. As such, the measurement system 204 may be used to couple to a processing system 230 to provide dynamic measurements of a concentration C of a material in the fluid sample 232, as the fluid sample 232 passes through the measurement system 204. As such, the processing system 23 may represent any suitable system generating a fluid sample to be measured, such as a chromatography system, a protein purification system, a filtration systems, or other fluid processing system, to name a few non-limiting embodiments.

In the scenario of FIG. 2, in operation, the MMLS 202 may operate generally according to the principles of operation of MMLS 102, discussed above. After entering the sample chamber vessel 210, the composite probe signal 214 will pass from the probe tip 108A and through the fluid sample 232, exiting the sample chamber vessel 201 through chamber wall 220, which wall may include a transparent window 222. In turn, the absorbance of the fluid sample 232 may be represented as A, so that the concentration C of a material in fluid sample 232 may be determined by measuring changes in A as a function of changes in l, as discussed above. Again, the concentration C may be determined for each of wavelengths 272 nm, 280 nm, and 310 nm, where this concentration C may represent the concentration of one or more materials in the fluid sample 232. As discussed with respect to FIG. 4, the concentration C may be measured in a dynamic fashion.

As noted above, DA/DL may be monitored as a function of time between successive instances (T1 to T2, T2 to T3, etc.) to determine any changes in C for a given substance over time. Because the fluid sample 232 is flowing through the sample chamber vessel 210, changes in concentration C over time for one or more substances in fluid sample 232 may be contemplated. Thus, the absorption spectroscopy apparatus 200 provides an ability to monitor concentration changes in real time. Because multi-monochromatic spectra may be acquired over a microsecond timeframe, for example, such changes in C may be detected rapidly, such as multiple times per second.

FIG. 3A depicts general features of an absorption spectroscopy system 300, in accordance with further embodiments of the disclosure. The absorption spectroscopy system 300 may include an MMLS 102, detector 106, optic probe 108, described previously with respect to FIG. 1. The measurement instrument 304 may be generally the same as measurement module 104, where in the particular embodiment shown, the sample vessel 110 is a self-contained, closed chamber. The absorption spectroscopy system 300 further includes a controller 310, which controller may be coupled to the measurement module 104, as well as the MMLS 102. The controller 310 may include an LED drive component 312, which component may be arranged to output a series of LED drive signals over a brief interval to drive the LED 102A, LED 102B, and LED 102C, in order to output the plurality of LED signals that form the composite probe signal 114. The controller 310, may further include a motor control component 314 that is coupled to a motor assembly 306 (which assembly may include a motor (such as a linear drive motor) and/or a sensor (such as sensor encoder, not separately shown), to direct movement of the optic probe 108 and/or to receive position information with respect to the optic probe 108, in order to vary L and/or determine L for any given instance. The controller 310 may further include a measurement interface 316, to receive intensity information from the detector 106. In some examples, the controller 310 may be coupled to a computer 318, via an interface 320, for example. In some examples, the controller 310 may form part of a computer or similar computing device, which device may or may not be located remotely from the measurement instrument 304.

As such, the controller 310 may integrate motor control, light source control, and data acquisition under control of a single micro-controller. In particular, MMLS 102 control and data acquisition may be synchronized to motion of the optic probe 108. In some examples, measurements of concentration C may be taken while the optic probe 108 moves in either of two opposite directions, while L is increasing or decreasing. The use of a single controller to control the various components of absorption spectroscopy system 300 allows for extremely tight synchronization (in the microsecond range) between the optic probe 108 movement, generation of the composite probe signal 114, and measurement of intensity at detector 106.

FIG. 3B depicts one variant of the system of FIG. 3A, where like components are labeled the same. The absorption spectroscopy system 350 differs from the embodiment of FIG. 3A, in that the measurement apparatus 354 includes a sample chamber vessel 210, described above, which vessel may be appropriate for dynamic measurements when a fluid sample 232 is flowing from an external system.

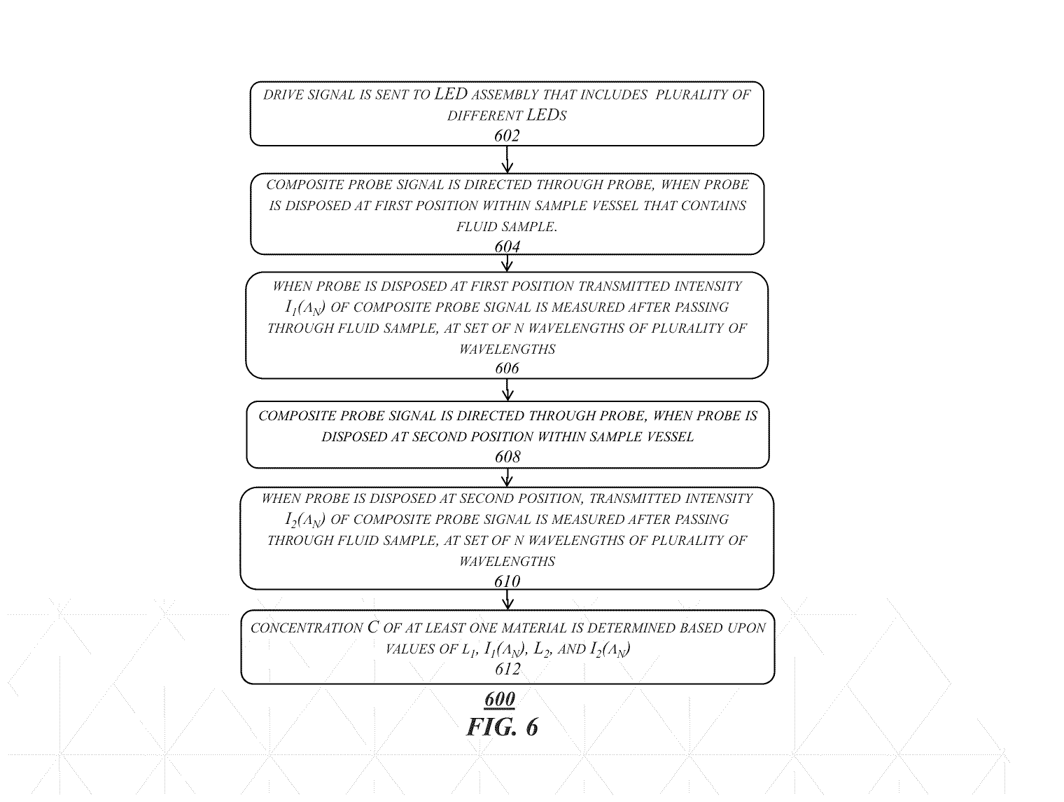

FIG. 6 illustrates an exemplary process flow 600. At block 602, a drive signal is sent to an LED assembly that includes a plurality of different LEDs. The LED assembly may include two or more LEDs that operate to generate light (more precisely, electromagnetic radiation in the UV-to IR range) at two or more wavelengths (frequencies), respectively. The drive signal may represent separate signals that are sent individually to different LEDs of the LED assembly or a single signal that is received by each of the plurality of LEDs. The drive signal may cause the different LEDs of the LED assembly to emit radiation as a plurality of probe signals at different wavelengths that, when combined together, form a composite probe signal composed of multi-monochromatic radiation. In some examples, the plurality of probe signals may be emitted from the plurality of different LEDs simultaneously, or may be emitted sequentially.

At block 604, the composite probe signal is directed through a probe, when the probe is disposed at a first position within a sample vessel that contains a fluid sample. The composite probe signal may be formed by an optical coupler that combines a plurality of probe signals, and outputs the plurality of probe signals as a composite probe signal. The probe may be formed of an optical fiber or an optical fibrette that is coupled to receive the composite probe signal and to direct the composite probe signal along a probe axis, through the fluid sample, to be received by a detector. When the probe is disposed at the first position, the composite probe signal travels along a first path that defines a first path length L₁ of the composite probe signal through the fluid sample.

Note that plurality of probe signals may be generated and combined to form the composite probe signal over a short interval, such as a few microseconds, so the composite probe signal represents the plurality of probe signals being directed through the probe nearly simultaneously. An advantage of providing the plurality of probe signals nearly simultaneously is that the different probe signals at the different wavelengths may be detected in a single instance, meaning over a very short interval, such as less than a millisecond, or less than 100 microsecond, or less than 10 microseconds. By detecting the different probe signals in a single instance, even if the probe is continuously moving, on the order of less than one millimeter per second, the probe will appear essentially stationary over the duration of the single instance such that the detected intensity of the different wavelengths representing the different probe signals will correspond to just one path length L. Note that in some embodiments the probe may be stationary, and therefore may be located at the first position over a short interval that is greater than the duration of the ‘instance’ required to detect the different signals at the different wavelengths. In this latter case, the path length L will be precisely the same for each different peak recorded at the detector.

At block 606, when the probe is disposed at the first position a transmitted intensity I₁(lₙ) of the composite probe signal is measured after passing through the fluid sample, at a set of n wavelengths of the plurality of wavelengths. In other words, at each wavelength a transmitted intensity is measured, corresponding to a wavelength of radiation emitted by one of the LEDs of the LED assembly

At block 608 the composite probe signal is directed through the probe, when the probe is disposed at a second position within a sample vessel that contains a fluid sample. When the probe is disposed at the second position, the composite probe signal travels along a second path that defines a second path length L₂ of the composite probe signal through the fluid sample. In different embodiments, the composite probe signal may be directed through the probe and fluid sample after the probe has been moved from the first position to second position and is stationary, or alternatively, the composite probe signal may be directed through the probe during continuous movement of the probe.

At block 610, when the probe is disposed at the second position a transmitted intensity I₂(lₙ) of the composite probe signal is measured after passing through the fluid sample, at a set of n wavelengths of the plurality of wavelengths. In other words, at each wavelength, corresponding to a wavelength of radiation emitted by one of the LEDs of the LED assembly, a transmitted intensity is measured.

At block 612, a concentration C of at least one material is determined based upon the values of L₁, I₁(lₙ), L₂, and I₂(lₙ). In one example, the concentration C may be determined by determining a concentration value C₁ at the plurality of different wavelengths for a single substance, based upon the detected optical intensity of the composite probe signal and the plurality of probe positions. In a particular variant, multiple different peaks at different wavelengths may be used to determine C for a single compound of interest in the following manner: A selected peak at a ‘main’ wavelength lm may be used to calculate an uncorrected concentration of the substance of interest. Other peaks, such as a second and a third peak in the example of three LEDs may be selected that correspond to wavelengths where there is not absorbance by the substance of interest. By measurement of these peaks at these non-absorbing wavelengths, the attenuation caused by scattering of particles may be determined, which attenuation may be used to correct the calculated absorbance at the main wavelength lm and thus will provide a corrected value for the calculated concentration C.

In another example, the determining of C may involve determining a first concentration value C₁ at a first wavelength of the plurality of different wavelengths for a first substance, and determining a second concentration value C₂ at a second wavelength of the plurality of different wavelengths for a second substance, different from the first substance. In this example, a value of C can be calculated from the Beer Lambert law for each different wavelength, corresponding to different substances, when the value of e is known for each of the different substances being measured.

While the present arrangement has been disclosed with reference to certain embodiments, numerous modifications, alterations and changes to the described embodiments are possible without departing from the spirit and scope of the disclosed arrangement, as defined in the appended claims. Accordingly, it is intended that the present arrangement not be limited to the described embodiments, but that it has the full scope defined by the language of the following claims, and equivalents thereof.

1. An apparatus, comprising:
a light emitting diode (LED) assembly, comprising a plurality of LEDs that output radiation at a plurality of different wavelengths, respectively, the LED assembly arranged to output a composite probe signal at a plurality of instances, wherein the composite probe signal comprises a plurality of probe signals, generated from the plurality of LEDs, respectively; and
a measurement module, comprising:
an optic probe to direct the composite probe signal through a fluid sample, while moving between a plurality of probe positions at the plurality of instances; and
a detector, disposed to detect, at the plurality of instances, a transmitted intensity of the composite probe signal at the plurality of different wavelengths after the composite probe signal passes through the fluid sample.

2. The apparatus of claim 1, the light emitting diode assembly further comprising: an optical coupler to receive the plurality of probe signals from the plurality of LEDs, respectively, and output the plurality of probe signals as the composite probe signal to the measurement module.

3. The apparatus of claim 1, wherein the optic probe comprises an optical fibrette coupled to receive the composite probe signal and to direct the composite probe signal along a probe axis to the detector.

4. The apparatus of claim 3, the measurement module further comprising a linear drive motor, mechanically coupled to the optical fibrette, and arranged to move the optical fibrette along the probe axis.

5. The apparatus of claim 5, further comprising a controller, the controller comprising:
an LED drive component to output a LED drive signal to drive the plurality of LEDs to output the plurality of LED signals; and
a motor control component to send a motor drive signal to move the optical fibrette along the probe axis.

6. The apparatus of claim 5, the measurement module further comprising a linear drive motor home sensor encoder, coupled to the a motor control component.

7. The apparatus of claim 1, further comprising:
an analysis component to determine a concentration value C₁ at the plurality of different wavelengths l for a single substance, based upon the transmitted intensity of the composite probe signal at the plurality of probe positions, at the plurality of instances.

8. The apparatus of claim 1, wherein a concentration value C₁ at a first wavelength l₁ of the plurality of different wavelengths corresponds to a concentration of a first substance, and wherein a concentration value C₂ at a second wavelength l₂ of the plurality of different wavelengths, corresponds to a concentration value for a second substance, different from the first substance.

9. A method of determining a concentration of at least one material, comprising:
providing an LED assembly comprising a plurality of LEDs to direct a composite probe signal through a fluid sample that contains the material, wherein the composite probe signal comprises a plurality of probe signals, generated at a plurality of different wavelengths;
directing the composite probe signal through a probe when the probe is disposed at a first position within a sample vessel that contains the fluid sample, wherein the first position defines a first path length L₁ of the composite probe signal through the fluid sample;
measuring a transmitted intensity I₁(lₙ) of the composite probe signal after passing through the fluid sample, at a set of n wavelengths of the plurality of wavelengths;
directing the composite probe signal through the probe when the probe is disposed at a second position, defining a second path length L₂ of the composite probe signal through the fluid sample;
measuring a transmitted intensity I₂(lₙ) of the composite probe signal after passing through the fluid sample at the set of n wavelengths of the plurality of wavelengths; and
determining a concentration C of the at least on material based upon L₁, I₁(lₙ), L₂, and I₂(lₙ).

10. The method of claim 9, wherein the composite probe signal is formed by an optical coupler that combines the plurality of probe signals, and outputs the plurality of probe signals as the composite probe signal to a measurement module.

11. The method of claim 9, wherein the probe comprises an optical fibrette coupled to receive the composite probe signal and to direct the composite probe signal along a probe axis to a detector.

12. The method of claim 9, wherein the fluid sample flows through the sample vessel during an interval spanning at least between the directing the composite probe signal when the probe is disposed at the first position and the measuring the transmitted intensity I₂(lₙ) of the composite probe signal when the probe is disposed at the second position.

13. The method of claim 11, wherein the composite probe signal is generated by: outputting a plurality of LED drive signals to the plurality of LEDs, respectively, in order to trigger the plurality of LEDs to output the plurality of probe signals, the method further comprising:
sending a motor drive signal to move the optical fibrette along the probe axis from the first position to the second position.

14. The method of claim 9, the determining the concentration C comprising: determining a concentration value C₁ at the plurality of different wavelengths for a single substance, based upon the transmitted intensity of the composite probe signal at the first probe position and the second probe position.

15. The method of claim 9, wherein the determining the concentration C comprises determining a first concentration value C₁ for a first substance at a first wavelength I₁ of the plurality of different wavelengths, and determining a second concentration value C₂ for a second substance, different from the first substance at a second wavelength l₂ of the plurality of different wavelengths.

16. The method of claim 15, where in the first substance and second substance are chosen from a group including DNA, RNA, and monoclonal antibodies.

17. The method of claim 9, wherein the probe is disposed at the first position at a first instance and is disposed at the second position at a second instance, the method further comprising:
directing, at a plurality of additional instances, the composite probe signal through the probe when the probe is disposed at a plurality of additional positions, respectively, defining a plurality of additional path lengths L_{z} of the composite probe signal through the fluid sample; and
measuring, at the plurality of additional instances, a transmitted intensity I_{z}(lₙ) of the composite probe signal after passing through the fluid sample at the set of n wavelengths of the plurality of different wavelengths,
wherein a measurement rate between the measuring is between 1 Hz and 100 Hz.

18. The method of claim 9, wherein the measuring the transmitted intensity I₁(lₙ) of the composite probe signal is performed by a single detector.

19. An absorption spectroscopy system, comprising:
a light emitting diode (LED) assembly, comprising a plurality of LEDs that output radiation at a plurality of different wavelengths, respectively, the LED assembly arranged to output a composite probe signal at a plurality of instances, wherein the composite probe signal comprises a plurality of probe signals, generated from the plurality of LEDs, respectively;
a measurement module, comprising:
an optic probe to direct the composite probe signal through a fluid sample, while moving between a plurality of probe positions at the plurality of instances; and
a detector, disposed to detect, at the plurality of instances, a transmitted intensity of the composite probe signal at the plurality of different wavelengths after the composite probe signal passes through the fluid sample; and
a controller arranged to synchronize a triggering of the plurality of LEDs with the data acquisition from the detector at the plurality of instances.

20. The absorption spectroscopy system of claim 19, the light emitting diode assembly further comprising: an optical coupler to receive the plurality of probe signals from the plurality of LEDs, respectively, and output the plurality of probe signals as the composite probe signal to the measurement module.
